(19) United States
(12) Patent Application Publication
(10) Pub. No.: US 2007/0118530 A1
(43) Pub. Date: May 24, 2007

(54) Scheduling of software updates

(75) Inventors: Trevin M. Chow, Redmond, WA (US); Asim Memon, Redmond, WA (US); Dilip K. Pai, Bellevue, WA (US); Naresh Jain, Redmond, WA (US); Wei Jiang, Redmond, WA (US); Yordan I. Rouskov, Kirkland, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/282,290

(22) Filed: Nov. 18, 2005

(51) Int. Cl. G06F 17/30

(52) U.S. Cl. 707/10

(57) ABSTRACT

Software updates are described. In an implementation, a method includes forming an authentication request to be communicated to an authentication service over a network that includes a version identifier of at least one application module of a client. A response is received to the authentication request which includes an indication of whether an update is available for the at least one application module and a token that verifies the authentication.

### BACKGROUND

Users have access to a wide range of application modules that provide functionality when executed by a computing device. For example, an operating system may be utilized in conjunction with a plurality of other application modules to provide communication (e.g., email and instant messaging), productivity (e.g., word processing, spreadsheets, drawing, presentations, and so on), information retrieval (e.g., web browsing), and so forth. Because the users typically desire increased functionality from each of these application modules, programmers continually work to provide updates to the application modules. Distribution of these updates to the users, and more particularly the user's devices, however, may be difficult.

A traditional technique that was utilized to update application modules, for instance, distributed new versions of the application modules that were stored on computer-readable media (e.g., a CD-ROM), which was then purchased by the user. The user, when using this technique, manually loaded the new versions onto the computing device, which was both time consuming and resulted in user frustration. A technique that was developed to address these problems provided the software updates over a network, such as to expose software updates at a service that is accessible to the user over a network. However, this technique typically required each user to poll the service to determine whether an update was available. Accordingly, as the number of users increased, so too did the burden on the service which was targeted by the polling, even to the point where failures may be encountered due to overburdening of the service. Therefore, this technique may also result in user frustration and is burdensome not only to the user, but also the network and computing resources utilized to provide the updates.

### SUMMARY

Software updates are described. Provision of software updates for an application module may be scheduled such that different subsets of a plurality of clients are notified as to the availability of a software update at different times. For example, a group of clients, when polling to determine whether an update is available, may receive an indication that the update is not available while another group of clients may receive an indication that it is available. In this way, a service which provides the updates may “throttle” how many clients receive the indications, and therefore manage a corresponding burden on the service in providing the updates. Notification of the software updates may also be incorporated within an authentication service such that a single request may be utilized to authenticate the client (e.g., the client's identity for accessing a service) as well as determine whether updates are available for the client.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of an environment 100 in an exemplary implementation that is operable to employ techniques for updating application modules.

FIG. 2 is an illustration of a system in an exemplary implementation showing functionality of an update service of FIG. 1 as incorporated within an authentication service.

FIG. 3 is a flow diagram depicting a procedure in an exemplary implementation in which provision of updates is scheduled according to an update schedule.

FIG. 4 is a flow diagram depicting a procedure in an exemplary implementation in which an authentication request from a client is also utilized to determine whether an update for an application module of the client is available.

FIG. 5 is a flow diagram depicting a procedure in an exemplary implementation in which

The same reference numbers are utilized in instances in the discussion to reference like structures and components.

### DETAILED DESCRIPTION

Overview

Software updates are described. Traditionally, software updates that were provided over a network required each user to poll the service to determine whether an update was available. Accordingly, as the number of users increased, so too did the burden on the service which was targeted by the polling, even to the point where failures may be encountered due to overburdening of the service. For example, a release of a new software update for a popular application module (e.g., an instant messaging module) may result in millions of attempts by user's to obtain the update in a relatively short amount of time. Therefore, a provider of the update may encounter update errors due to the large amount of resources that are to be utilized to provide these updates over those typically used in day-to-day operation. In an attempt to avoid these errors, the provider may obtain additional resources (e.g., hardware resources, network bandwidth, and so on) to address this increased demand, which may be costly and inefficient.

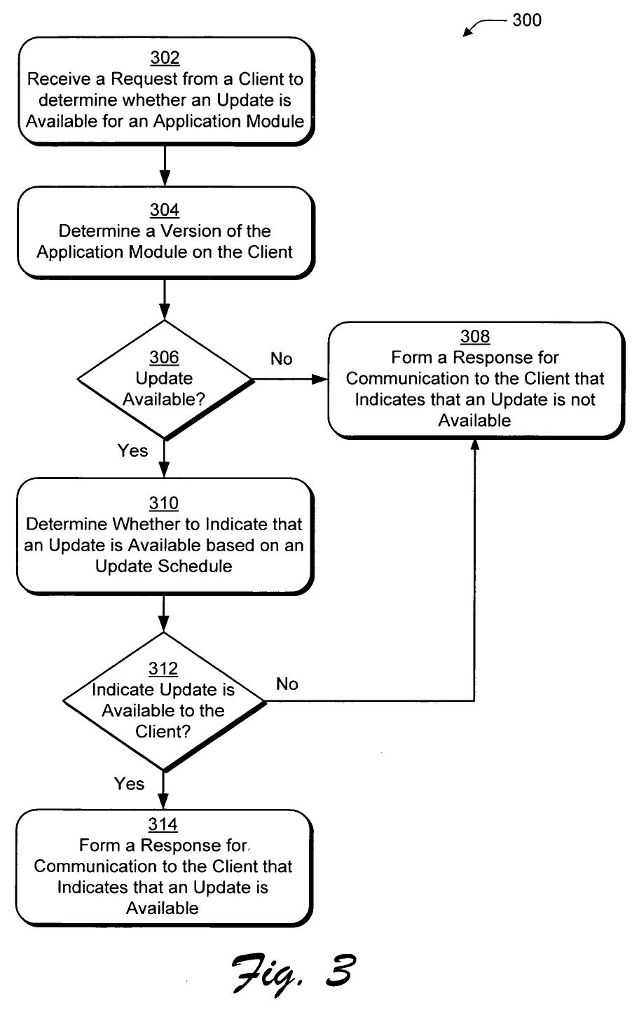

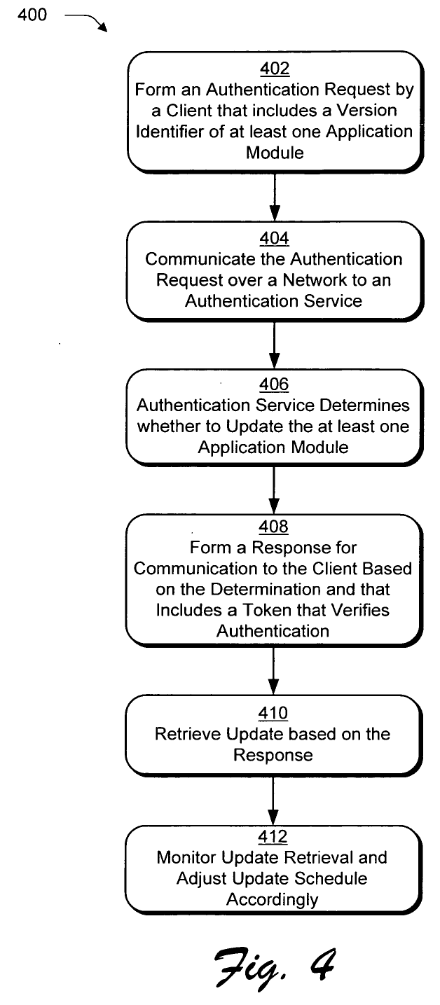

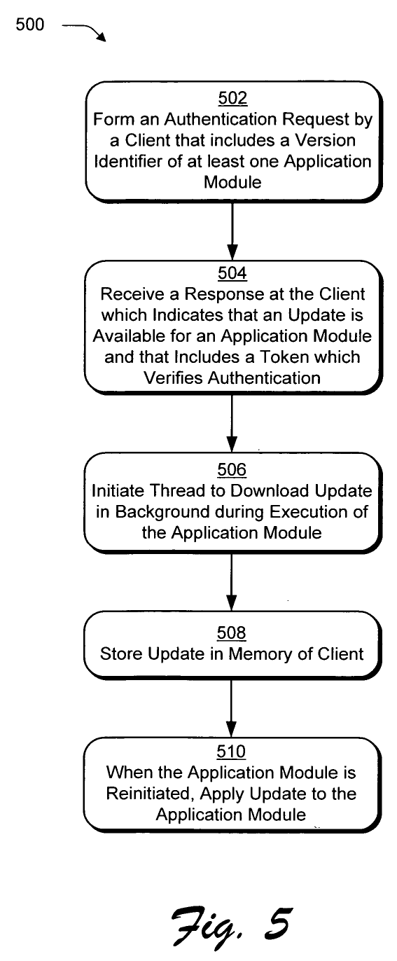

In an implementation, provision of software updates for an application module is scheduled such that different subsets of a plurality of clients are notified as to the availability of a software update at different times. For example, a group of clients, when polling to determine whether an update is available, may receive an indication that the update is not available. During a corresponding period of time, however, another group of clients may receive an indication that the update is available. In this way, a service that provides the updates may “throttle” how many clients receive the indications, and therefore manage a corresponding burden on the service in providing the updates. In other words, the service may “spread out” when users receive the updates, further discussion of which may be found in relation to FIG. 3. Notification of the software updates may also be incorporated within an authentication service such that a single request may be utilized to authenticate the client (e.g., the client's identity for accessing a service) as well as determine whether updates are available for software of the client, further discussion of which may be found in relation to FIGS. 4 and 5.

In the following discussion, an exemplary environment is first described which is operable to implement the software update techniques. Exemplary procedures are then described which may be employed in the exemplary environment, as well as in other environments.

Exemplary Environment

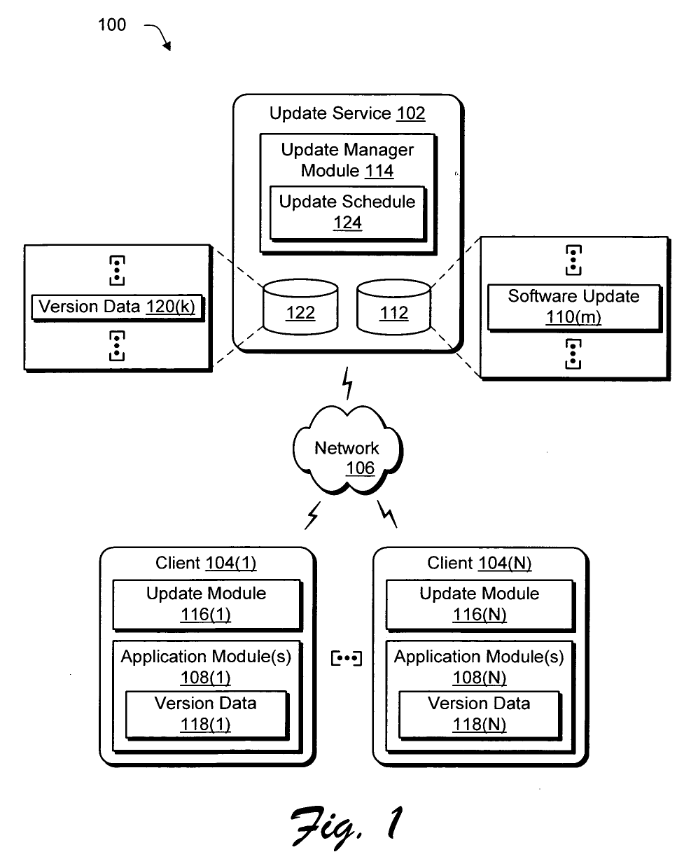

FIG. 1 illustrates an environment 100 in an exemplary implementation that is operable to employ techniques for updating application modules. The illustrated environment 100 includes an update service 102 and a plurality of clients 104(1), . . . , 104(N) that are communicatively coupled, one to another, via a network 106. The clients 104(1)-104(N) may be configured in a variety of ways for accessing the network 106. For example, one or more of the clients 104(1)-104(N) may be configured as a computing device, such as a desktop computer, a mobile station, an entertainment appliance, a set-top box communicatively coupled to a display device, a wireless phone, a game console, and so forth. Thus, the clients 104(1)-104(N) may range from full resource devices with substantial memory and processor resources (e.g., personal computers, game consoles) to low-resource devices with limited memory and/or processing resources (e.g., traditional set-top boxes, hand-held game consoles). The clients 104(1)-104(N) may also relate to a person and/or entity that operate the clients. In other words, one or more of the clients 104(1)-104(N) may describe logical clients that include users, software, and/or devices.

Although the network 106 is illustrated as the Internet, the network 106 may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks. For instance, client 104(1) may be communicatively coupled directly to the update service 102 via the Internet, while client 104(N) is communicatively coupled to the update service 102 via a dial-up connection to an Internet service provider. A wide variety of other instances are also contemplated without departing from the spirit and scope thereof.

Each of the plurality of clients 104(1)-104(N) is illustrated as including a respective one or more of a plurality of application modules 108(1)-108(N). Application modules 108(1)-108(N) are executable on the respective clients 102(1)-102(N) to provide a variety of functionality. For example, one or more application modules 108(1)-108(N) may be configured to send and receive email. Email employs standards and conventions for addressing and routing such that the email may be delivered across the network 106 utilizing a plurality of devices, such as routers, other computing devices (e.g., email servers), and so on. In another example, one or more of the application modules 108(1)-108(N) may be configured to provide one or more business productivity functions such as word processing, database, spreadsheet, and presentation functionality. In a further example, application modules 108(1)-108(N) may be configured to provide one or more software development functions such as development interfaces, tools, management, and compilation. Further, the application modules 108(1)-108(N) may provide other computing functions such as graphic design, web browsing, and media management, editing, viewing, and/or playback.

In yet another example, the application modules 108(1)-108(N) may be configured to send and receive instant messages. Instant messaging provides a mechanism such that a plurality of clients 104(1)-104(N), when participating in an instant messaging session, may send text messages to each other. Instant messages are typically communicated in real time, although delayed delivery may also be utilized, such as by logging the text messages when one of the clients 104(1)-104(N) is unavailable, e.g., offline. Thus, instant messaging may be though of as a combination of e-mail and Internet chat in that instant messaging supports message exchange and is designed for two-way live chats for synchronous communication in real time. For instance, like a voice telephone call, an instant messaging session may be performed in real-time such that each user may respond to each other user as the instant messages are received. Although a range of functionality that may be employed by the instant messages has been described, a wide variety of other functionality may also be provided, such as an operating system and so forth.

As previously described, software developers may make continual improvements to the application modules 108(1)-108(N) and provide these improvements as software updates 110(m) (where “m” can be any integer from one to “M”), which are illustrated as stored in storage 112 of the update service 102. To manage the software updates 110(m), the update service 102 includes an update manger module 114 that is executable to store, locate and provide the software updates 110(m).

For example, each of the clients 104(1)-104(N) is illustrated as including a respective update module 116(1)-116(N) that is executable to automatically poll the update service 102 to determine whether a software update is available for the respective applications modules 108(1)-108(N). The update manager module 102, for instance, may determine whether a respective software update 110(m) is available by comparing version data 118(1)-118(N) of the application modules 108(1)-108(N) with version data 120(k) (where “k” can be any integer from one to “K”) stored in storage 122 at the update service 102. When a software update 110(m) is available, the update service 102 may notify the clients 104(1)-104(N) of this availability, each of which may then initiate a process in order to obtain the software updates 110(m).

However, as previously described the software updates 110(m) may be desired by a vast number of clients 104(1)-104(N) such that the provision of the software updates 110(m) may overtax the update service 102. For example, the application modules 108(1)-108(N) may be configured as instant messaging modules that are utilized by millions of respective clients 104(1)-104(N) to participate in instant messaging. If each of the millions of clients 104(1)-104(N) requested updates to the respective application modules 108(1)-108(N) in a relatively short amount of time, however, these requests may exceed the resource capabilities (e.g., hardware, software and/or network resources) of the update service 102 that is configured to provide the software updates 110(m). Therefore, the update service 102, through execution of the update manager module 114, may utilize an update schedule 124 to determine which of the clients 104(1)-104(N) may receive an update at a particular point in time.

The update schedule 124 may be configured in a variety of ways to control which clients 104(1)-104(N) are able to receive updates. For example, the update schedule 124 may be configured as an update ratio (e.g., three out of every ten requests are informed as to the existence of an update), request threshold (e.g., after receipt of “x” number of requests, the respective client is notified of the update), scheduled download (e.g., the client is “slotted” to a particular time, at which, the client is authorized to download the software update 110(m)), and so on, further discussion of which may be found in relation to the following figures. Thus, the update manager module 114 may “throttle” the number of software updates 110(m) that are provided in a particular amount of time, thereby “spreading out” the demand of the clients 104(1)-104(N) and conserving software resources of the update service 102, network 106, and clients 104(1)-104(N) themselves.

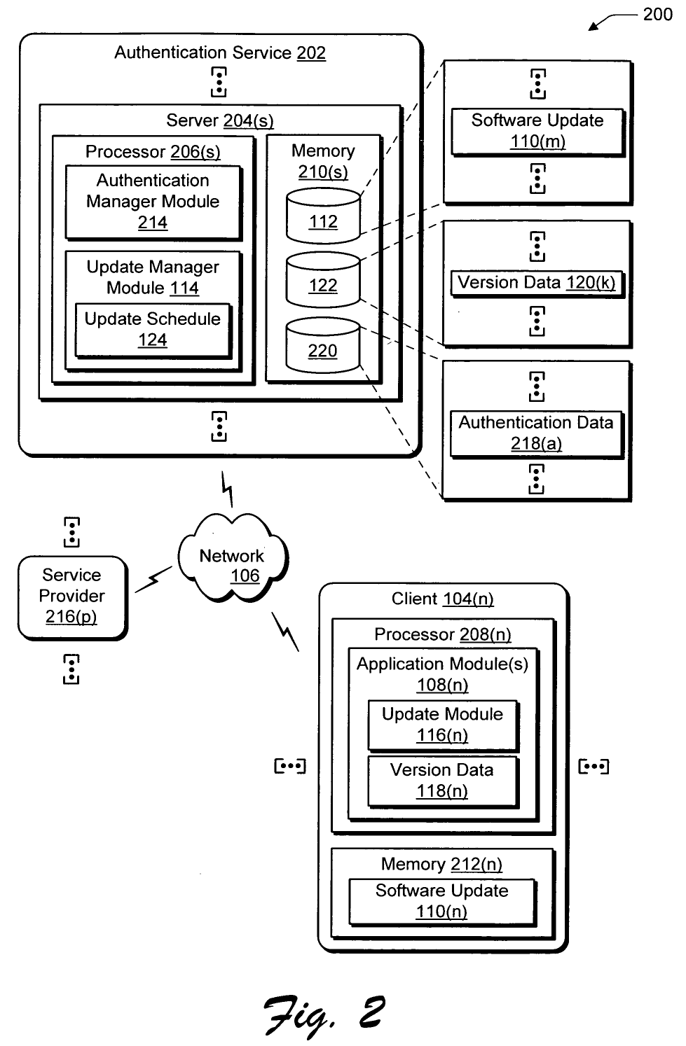

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the update techniques described below are platform-independent, meaning that the techniques may be implemented on a variety of commercial computing platforms having a variety of processors.

FIG. 2 illustrates a system 200 in an exemplary implementation showing functionality of the update service 102 of FIG. 1 as incorporated within an authentication service 202. The authentication service 202 is illustrated as being implemented by one or more servers 204(s) (where “s” can be any integer from one to “S”) and the client 104(n) is illustrated as a client device, which may or may not correspond to one or more of the clients 104(1)-104(N) of FIG. 1. The servers 204(s) and the clients 104(n) each include a respective processor 206(s), 208(n) and respective memory 210(s), 212(n).

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 210(s), 212(n)is shown, respectively, for the servers 204(s) and clients 104(n), a wide variety of types and combinations of memory may be employed, such as random access memory (RAM), hard disk memory, removable medium memory, and other computer-readable media.

The authentication service 202 includes an authentication manager module 214 that is representative of functionality to authenticate identity of the clients 104(n). In other words, the authentication manager module 214 may be executed to verify that the clients 104(n) “are who they say they are”. Additionally, an indication of this authentication may be provided to one or more other service providers 216(p) (where “p” can be any integer from one to “P”) to enable the client 104(n) to access the service providers 216(p) through a single “logon”. For example, the client 104(n), through execution of the application module 108(n), may communicate over the network 106 with the authentication service 202 and provide authentication data (e.g., client name and password) to the authentication manager module 214. The authentication manager module 214 is executable to verify the authentication data received from the client 104(n) using authentication data 218(a) that is stored in storage 220 that corresponds to the client 104(n).

When verified, the authentication manager module 214 is also executable to provide an indication (e.g., a token) that the verification was successfully performed to the client 104(n). The client 104(n) may then provide this indication (e.g., the token) to the service providers 216(p) when attempting access. Thus, the service providers 216(p) may be configured to recognize the indication, but need not be configured to perform the authentication themselves, thereby “offloading” the authentication process to the authentication service 202. A wide variety of other authentication examples are also contemplated without departing from the spirit and scope thereof, such as through communication between the service providers 216(p) and the authentication service 202 when the client 104(n) attempts access to verify that the authentication has been performed.

The authentication service 202 in this instance incorporates the functionality of the update service 102 of FIG. 1 through inclusion of the update manager module 114 and update schedule 124, which are illustrated as being executed on the processor 206(s) and are storable in memory 210(s). For example, the client 104(n) may provide authentication data (e.g., client name and password) as previously described to authenticate the identity of the client 104(n). Along with the authentication data, the client 104(n) may also provide version data 118(n) that indicates which version of the application modules 108(n) are stored locally on the client 104(n). In response, the authentication service 202 may execute the authentication manager module 214 to authenticate the client 104(n) as well as the update manager module 114 to provide software updates 110(m), if available, for the application module 108(n). In this way, a single authentication request may be utilized to both update and authenticate the client 104(n).

The provision of updates from the authentication service 202 to the clients 104(n) may also be managed through use of the update schedule 124 as previously described in relation to FIG. 1. For example, clients were traditionally informed as to the availability of software updates by “polling” server to check for the updates. Therefore, use of this traditional technique involved continual polling by the client even though updates may not be available for a significant period of time, which may burden the client, the network and the server receiving the polled requests. Furthermore, the server that is being polled did not have an efficient way to manage the requests since the clients themselves are initiating the connections on their own accord. Therefore, the server was typically provided with excess capacity than was used during typical operation to address these requests, which was both inefficient and expensive.

By coupling the updates (and more particularly the update schedule 124) to the authentication service 202, however, the authentication service 202 may manage the updates by providing directives in an authentication response as to whether the client 104(n) should retrieve the software update. Therefore, the authentication service 202 may “throttle” the number of software updates 110(m) that are provided during a period of time as well as reduce latency traditionally experienced by the client when performing dedicated “polling” of the service for updates. Additionally, the software update 110(n) may be downloaded during execution of the application module 108(n) in the “background” and implemented a subsequent time the application module 108(n) is initiated, thereby keeping the implementation of the software update 110(n) from interfering with the execution of the application module 108(n). Further discussion of software updates may be found in relation to the following exemplary procedures.

It should be noted that although separate modules have been illustrated to depict the functionality represented by the modules in FIGS. 1 and 2, the modules may be further combined, separated, and so on without departing from the spirit and scope thereof. Further, although the software updates 110(m) are illustrated as stored by the server 204(s), the authentication service may also “point to” updates that are stored elsewhere, e.g., by another service. For example, the authentication response may include an indication that authentication was successfully performed (e.g., the token previously described) as well as a network address indicating where the software updates may be obtained. A variety of other instances are also contemplated.

Exemplary Procedures

The following discussion describes update techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

FIG. 3 depicts a procedure 300 in an exemplary implementation in which provision of updates is scheduled according to an update schedule. A request a received from a client to determine whether an update is available for an application module (block 302). For example, the client 104(1) may execute an update module 116(1) that periodically polls an update service 102 to determine whether an update is available for an application module 108(1). The update service 102, in response to the request, determines a version of the application module on the client (block 304).

The update manager module 114, for instance, may compare version data 118(1) received in the request with version data 120(k) to determine whether an update is available (decision block 306). When an update is not available (“no”) from decision block 306), a response is formed for communication to the client that indicates that an update is not available (block 308). Therefore, in this instance, an update is not available and therefore the client is provided an accurate indication of the unavailability.

When an update is available (“yes” from decision block 306), a determination is made as whether to indicate that the update is available based on an update schedule (block 310) and therefore determine whether to indicate that the update is available to the client (decision block 312). If so (“yes” from decision block 312), a response is formed for communication to the client that indicates that an update is available (block 314). If not (“no” from decision block 312), a response is formed for communication to the client that indicates that an update is not available (block 308).

For example, the update schedule may be configured as an update ratio such that, for every “x” number of requests, “y” number of responses are sent that indicate the update is available, where “y” is less than “x”. Therefore, by setting “x” and “y”, the update service 102 may manage how many clients are informed as to the availability of the updates, and therefore are provided with an opportunity to obtain the updates. In this way, the update service 102 may manage the provision of the software updates 110(m) even to “polling” clients. This management may also be performed dynamically, such that as fewer requests (i.e., “x”) are received over a period of time, a greater number of responses (e.g., “y”) are sent that indicate the availability of the update. The update schedule may also be configured in a variety of other ways to manage (i.e., “throttle”) prevision of the software updates, such as by also incorporating a threshold number of times particular clients request an available update before being given access to the update.

FIG. 4 depicts a procedure 400 in an exemplary implementation in which an authentication request from a client is also utilized to determine whether an update for an application module of the client is available. An authentication request is formed by a client that includes a version identifier of at least one application module of the client (block 402). For example, the client 104(n) may logon to the authentication service 102 and communicate an authentication request (block 404) that includes a client name and password (block 404). In addition, the update module 116(n) may automatically provide version data 118(n) of the application module 108(n) that is communicated along with the client name and password, i.e., the communication. In this way, the authentication service 202, along with the client's identity, is also informed as to which version of application modules 108(n) are included on the client 104(n).

The authentication service then determines whether to update the at least one application module (block 406). The update manage module 114, for instance, may be executed by the authentication service 202 to determine whether an update is available and whether to inform the client of the availability of the update, such as through use of the update schedule 124 as described previously in relation to FIG. 3.

A response is formed for communication to the client based on the determination and that includes a token that verifies authentication (block 408). The response, for instance, may indicate that an update is available based on an update ratio specified by the update schedule 124, a request threshold, a download schedule, and so on The response may also include a token which may be utilized by the client to access another service provider 216(p). For example, the token may enable the client 104(n) to access a website, an instant messaging service, online banking, and so on without resubmitting the authentication data, e.g., the client name and password.

The update is then retrieved based on the response (block 410). The response, for example, may include a network address of where to initiate a download of the update, may include the update itself, and so on. Additionally, update retrieval may be monitored and used to adjust the update schedule accordingly (block 412). For instance, a provider of the update (e.g., the authentication service 202) may monitor resource usage when providing the updates and use this monitoring to adjust the update schedule according to whether resources are or are not available. Thus, the resources used to provide the updates may be managed through use of the update schedule. A variety of other instances are also contemplated without departing from the spirit and scope thereof.

Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
forming an authentication request to be communicated to an authentication service over a network that includes a version identifier of at least one application module of a client; and
receiving a response to the authentication request which includes an indication of whether an update is available for the at least one application module and a token that verifies the authentication.

2. A method as described in claim 1, wherein the token is configured for use in accessing a plurality of service providers over the network without providing authentication data to each said service provider.

3. A method as described in claim 1, wherein an update schedule is used, at least in part, to determine whether to indicate that an update is available for the at least one application module.

4. A method as described in claim 3, wherein:
the indication matches the version number when the determination is made to indicate that the update is not available.
the indication is an updated version of the version identifier when the determination is made to indicate that the update is available.

5. A method as described in claim 3, wherein the update schedule controls how many said responses include indications which indicate that the update is available are provided during a period of time.

6. A method as described in claim 3, wherein the update schedule is configured as a ratio that describes how many said responses include indications that the update is available.

7. A method as described in claim 1, further comprising:
when the indication in the response indicates that the update is available, initiating a thread to perform a download of the update in a background during execution of the at least one application module; and
when the at least one application module is reinitiated, applying the update to the at least one application module.

8. A method comprising:
determining whether to indicate that an update is available for an application module of a client based on an update schedule; and
forming a response to be communicated to the client over a network that indicates whether the update is available based on the determination.

9. A method as described in claim 8, wherein:
the determining is performed in response to receipt of a request from the client; and
the request includes a version identifier of the application module.

10. A method as described in claim 9, wherein the request is part of a single authentication request that is utilized to verify the identity of the client, such that, the client may access a plurality of service providers over the network without providing authentication data to each said service provider.

11. A method as described in claim 9, wherein the indication in the response matches a version identifier of the application module of the client when the determination is made to indicate that the update is not available.

12. A method as described in claim 9, wherein the indication in the response is a version identifier that is an updated version of the version identifier of the application module of the client when the determination is made to indicate that the update is available.

13. A method as described in claim 8, further comprising determining whether the update is available for the application module and wherein the determining whether to indicate that the update is available is not performed when the update is not available.

14. A method comprising:
receiving a version identifier of an application module;
when an update is available for the application module based on the version identifier, determining whether to indicate that the update is available based on an update schedule that controls how many of a plurality of said indications indicate that the update is available; and
forming a response based the determining.

15. A method as described in claim 14, wherein:
the version identifier is includes as part of an authentication request received from a client over a network; and
the receiving, the determining and the forming are performed by an authentication service.

16. A method as described in claim 15, wherein the authentication request that is utilized to verify the identity of the client, such that, the client may access a plurality of service providers over the network without providing authentication data to each said service provider.

17. A method as described in claim 14, wherein the update schedule is configured as a ratio that describes how many said indications indicate that the update is available.

18. A method as described in claim 14, wherein the update schedule controls how many said indications indicate that the update is available are provided during a period of time.

19. A method as described in claim 14, wherein the indication matches the received version identifier when the determination is made to indicate that the update is not available.

20. A method as described in claim 14, wherein the indication is an updated version of the receiver version identifier when the determination is made to indicate that the update is available.
